(19) United States
(12) Patent Application Publication
(10) Pub. No.: US 2010/0120597 A1
(43) Pub. Date: May 13, 2010

(54) CENTRIFUGE WITH NON-SYNCHRONOUS DRIVE SYSTEM

(76) Inventor: David W. Hawes, Powys (GB)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/525,525

(22) PCT Filed: Feb. 4, 2008
(86) PCT No.: PCT/EP08/51368

§ 371 Date: Jan. 7, 2010

(30) Foreign Application Priority Data
Feb. 2, 2007 (GB) 0701942.5

(51) Int. Cl. B04B 5/06; B04B 5/02

(52) U.S. Cl. 494/22

(57) ABSTRACT

A centrifuge may include a main drive system having a first axis of rotation and a bobbin carrier having a bobbin axis of rotation that is parallel to and offset from the first axis of rotation. A transmission system may be connected to the main drive system via a differential in order to transmit power from the main drive system to rotate the carrier bobbin around the first axis of rotation and to rotate the carrier around the bobbin axis of rotation such that the bobbin can rotate around the first axis of rotation at a different speed than the bobbin rotates around the bobbin axis of rotation.

### CROSS-REFERENCE TO RELATED APPLICATIONS

The present application is a national phase application of PCT application PCT/EP/2008/051368 filed pursuant to 35 U.S.C. §371, which claims priority to GB 0701942.5 filed Feb. 2, 2007. Both applications are incorporated herein by reference in their entirety.

### TECHNICAL FIELD

This invention relates to non-synchronous drives for centrifuges, in particular centrifuges for use in counter current chromatography.

### BACKGROUND ART

Countercurrent chromatography (CCC) machines are used to separate particles in liquid mixtures. For an example of a CCC machine see WO 2003/086639. When separating polymers such as proteins, two aqueous phases are used for separation. However, the liquid aqueous phases currently used do not easily separate using current CCC machines. For polymers, it is an advantage to spin the coils more slowly than the rotation of the rotor, however using traditional CCC machines the flying leads will twist. The rotational speed of the rotor provides a base-line gravity gradient across the coil which contributes to retention of the stationary phase. The rotation speed of the coil column governs settling times and the tangential accelerations that promote mixing. In current CCC machines these speeds are linked by a 1:1 gearing requirement imposed by the flying leads, as using different gear ratios will result in the flying leads twisting as the columns rotate.

In the most common versions of the coil planet centrifuge the axis of the helical column is parallel and offset from the axis of the rotor. There are two basic types of parallel axis machines, I and J types—defined by their flying-lead characteristics and depend on the speed of the bobbin relative to the rotor. However these two basic machines only allow two different rotor speed/bobbin speed possibilities. Counter current chromatography machines that attempt to allow for variable rotation-revolution speed ratios are described in U.S. Pat. Nos. 4,277,017 and 4,287,061. However, for these machines the bobbins are still rotated synchronously around a main axis of rotation with a column to avoid twisting of the flying leads.

Therefore, a need remains for a non-synchronous centrifuge in which the speed of rotation of the bobbin and rotor can be independently changed.

### SUMMARY OF THE INVENTION

An embodiment of the invention is a centrifuge having a main drive system having a first axis of rotation, a bobbin carrier for mounting a bobbin so as to have an axis of rotation that is parallel to and offset from the first axis of rotation, a first transmission system connected to the main drive system and the bobbin carrier to transmit power from the main drive system to rotate the carrier bobbin around the first axis of rotation and to rotate the carrier around the bobbin axis of rotation and a first bobbin drive system connected to the transmission system for driving the carrier around the bobbin axis of rotation.

The first transmission system is connected to the bobbin carrier by a differential such that the bobbin can rotate around the first axis of rotation at a different speed than the bobbin rotates around the bobbin axis of rotation. Having the differential allows the bobbin to rotate around the bobbin axis of rotation at a different speed and direction from the rotation of the bobbin about the main axis of rotation. The differential will compensate for the twisting of the flying leads that would otherwise occur due to the difference between the speed that the bobbin rotates around the bobbin axis of rotation and the speed the bobbin rotates around the main axis of rotation.

In some embodiments, the centrifuge includes a second bobbin drive system connected to the bobbin carrier to drive the carrier around the bobbin axis independently of the first bobbin drive system. This allows the rotation of the bobbin about its own axis of rotation to be controlled independently from the revolution of the bobbin around the main axis of rotation and therefore prevent the flying leads from twisting when the bobbin is rotating about its axis at a different speed and/or direction from what it is revolving around the main axis. The bobbin carrier can be part of the bobbin through which it connects to the drive systems of the centrifuge or may be a separate carrier which holds the bobbin in the centrifuge. The carrier allows the bobbin to be removably attached to the centrifuge.

In some embodiments, the first bobbin drive system includes a main drive gear through which it connects to the main drive system, an intermediate drive gear connected to the first drive, and a differential gear that is connected to the intermediate drive gear and to the bobbin carrier.

The bobbin carrier can include a bobbin gear through which it connects the bobbin to the differential gear of the first bobbin drive system.

The differential gear can have a smaller diameter than the first drive gear and bobbin gear. This allows the centrifuge to be more compact.

In some embodiments, the gear ratio of the bobbin gear and the intermediate drive gear is 1:1. In some cases, the intermediate drive gear can have a smaller diameter than the main drive gear.

In some embodiments the bobbin carrier can rotate around the first axis of rotation at a faster speed than the bobbin carrier rotates around the bobbin axis of rotation.

Another embodiment of the invention is a centrifuge including a main drive system having a first axis of rotation, an outer carrier that is connected to the main drive system and that rotates around the first axis of rotation and a bobbin carrier within the outer carrier for mounting a bobbin so as to have a bobbin axis of rotation that is parallel to and offset from the first axis of rotation. The centrifuge includes a first bobbin drive system that is connected to the outer carrier for driving the bobbin carrier about the bobbin axis of rotation, a first differential that is connected to the first bobbin drive system, a second bobbin drive system connected to the bobbin carrier so as to drive the bobbin carrier around the bobbin axis of rotation independently of the first bobbin drive system, and a second differential connected to the second drive system. The first and second differentials are connected to the first and second bobbin drive systems such that the bobbin is rotatable about the first axis of rotation at a different speed than the bobbin is rotatable about the bobbin axis of rotation.

The first bobbin drive system includes a bobbin drive gear and the bobbin carrier has a bobbin gear, the bobbin drive gear being connected to the bobbin gear.

A centrifuge can further include a casing wherein the first differential is connected to a stationary gear, the stationary gear being connected to the casing of the centrifuge.

The second bobbin drive system includes a second bobbin drive gear, the second differential being connected to the second bobbin drive gear and to a second bobbin gear connected to the bobbin carrier.

A third embodiment of the invention is a countercurrent chromatography machine comprising the centrifuge described above.

### BRIEF DESCRIPTION OF THE DRAWINGS

FIG. 1 is a schematic diagram of a counter current chromatography apparatus.

FIG. 2 is a schematic diagram of another embodiment of a counter current chromatography.

### DETAILED DESCRIPTION

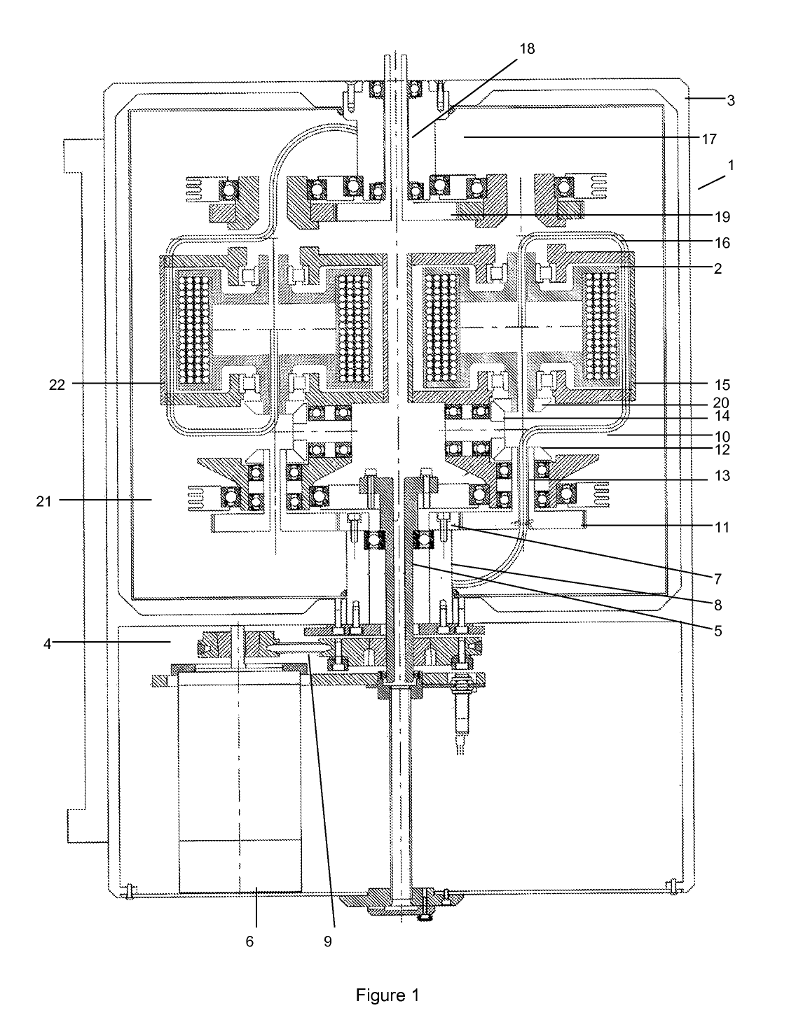

FIG. 1 shows an embodiment of a “J” type coil centrifuge for counter current chromatography. The centrifuge 1 allows the bobbin 2 to rotate around the first axis of rotation at a different speed and direction than the bobbin rotates around the bobbin axis of rotation without the flying leads twisting.

The centrifuge 1 includes a casing 3 to protect the components and to allow control of environmental conditions such as temperature. The centrifuge 1 includes a main drive system 4 that is attached to a transmission system. The main drive system 4 includes a main drive motor 6 that drives the drive belt 9 which in turn rotates the main drive shaft 5 of the transmission system around its axis of rotation. The main drive shaft 5 is connected to a stationary gear 7 that is non-rotatably attached to a support tube 8 holding the main drive shaft 5.

The main drive shaft 5 is connected to the first bobbin drive system 10 such that rotation of the main drive shaft 5 causes the first bobbin drive system to rotate about the axis of rotation of the main drive shaft.

The first bobbin drive system 10 includes a main drive gear 11, an intermediate drive gear 12 that is attached to the main drive gear 11 by a support shaft 13, and a differential bevel gear 14. The first bobbin drive system 10 is attached to a bobbin carrier 15 via the differential bevel gear 14. The bobbin carrier 15 holds the bobbin 2 including the coiled assembly to which the flying leads 16 are attached to.

As the first bobbin drive system rotates around the main axis of rotation, the bobbin carrier rotates around the main axis of rotation and around the bobbin axis of rotation, which is parallel to and offset from the first axis of rotation. In some embodiments, instead of the bobbin drive system rotating the bobbin about the bobbin axis of rotation via rotation of the bobbin carrier it is mounted in, the bobbin drive system may directly connect to the bobbin to rotate the bobbin about the bobbin axis of rotation. In this situation the bobbin carrier is part of the bobbin.

The second bobbin drive system 17 includes a bobbin drive shaft 18 powered by a motor (not shown) and a bobbin drive gear 19. The bobbin drive system 17 is connected to the bobbin carrier 15 via the second bobbin drive gear 19 and as the drive shaft 18 rotates the drive shaft 18 drives the bobbin carrier about the bobbin axis of rotation.

As the main drive gear 11 is rotated around the main axis of rotation by the main drive system 4, the main drive gear 11 rotates the bobbin carrier 15 and bobbin 2 around the main axis of rotation. The main drive gear 11 of the first bobbin drive system 10 is rotatably engaged with the stationary gear 7 of the transmission system such that as the first bobbin drive system 10 is rotated about the main axis of rotation, the main drive gear 11 rotates, which in turn causes the intermediate gear 12 to rotate. Rotating the intermediate gear rotates the differential gear 14 which causes the bobbin gear 20 and therefore the bobbin carrier 15 to rotate about the bobbin axis of rotation as the bobbin carrier 15 revolves around the main axis of rotation.

Therefore the bobbin carrier 15 is rotated simultaneously around the bobbin axis of rotation by two drive systems, directly by the second bobbin drive system 17 and indirectly by the main drive system 4 through the transmission system and first bobbin drive system 10. This allows for non-synchronous driving of the centrifuge.

In another embodiment, the differential can be a unit mounted on a rotor separate from the bobbin, with the rotor being driven around a first axis of rotation by the main drive system. The differential receives inputs from the rotor main drive system and a second bobbin drive system creating an output to the bobbin, causing the bobbin to rotate about its axis as the rotor rotates about the main axis of rotation. In this arrangement the bobbin is not directly connected to the second bobbin drive system instead the second bobbin drive system is directly connected to the differential.

As the bobbin is rotated about the bobbin axis of rotation by a drive system that is independent from the drive system that is rotating the bobbin around the main axis of rotation, the speed and direction of the bobbin's rotation can be changed independently of the speed and direction of the rotation of the bobbin around the main axis of rotation. The rotation about the second axis of rotation provided by the transmission system is dependant on the speed and direction of rotation round the main axis of rotation.

The differential gear allows for the bobbin gear carrier to rotate at a different speed than the main drive gear, but still maintain a 1:1 gear ratio between the bobbin gear and intermediate drive gear. Therefore even though the bobbin gear and intermediate drive gear can rotate at different speeds, as the 1:1 gear ratio is maintained between the two gears, the flying leads will not twist as the bobbin carrier rotates around the first axis of rotation and the bobbin axis of rotation. The differential gear automatically compensates for the twisting difference of the flying leads between the speed of the bobbin's rotation around the main axis of rotation and the speed of the bobbin's rotation around the bobbin axis of rotation. Therefore this allows the transmission system and the bobbin drive system to rotate the bobbin at different speeds and in different direction. In FIG. 1 the differential is shown as a bevel gear, however other arrangements may be used to achieve the differential action, such as spur gears or belt drives.

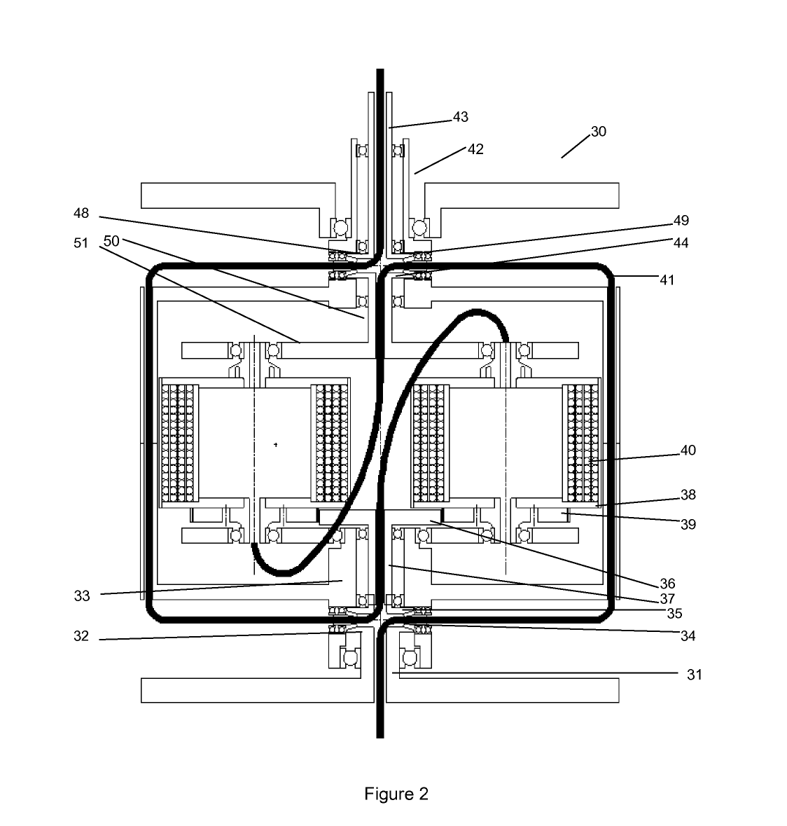

Referring to FIG. 2 a second embodiment of a “J” type coil centrifuge for counter current chromatography is shown.

The centrifuge 30 includes a main drive system (not shown) that rotates a shaft 42. Rotating the first shaft 42 in turn rotates an outer carrier 33 through which the flying leads 41 pass. A stationary shaft 31 is connected to a stationary gear 32. The stationary shaft is connected to the casing of the centrifuge and through which the flying leads 41 pass. The outer carrier 33 is connected to the first bobbin drive system such that rotating the outer carrier 33 causes rotation of the first bobbin drive system.

The gear 35 of the first bobbin drive system is connected to the stationary gear 32 via a first differential gear 34. The bobbin drive gear 36 of the first bobbin drive is connected to the bobbin carrier 38 via a bobbin gear 39.

The bobbin carrier 38 holds the bobbin 40 including the coiled assembly to which the flying leads 41 are attached. As the first bobbin drive system is rotated around the main axis of rotation by the main drive system, the first bobbin drive system rotates the bobbin carrier 38 and bobbin 40 around the main axis of rotation.

The differential gear 34 allows the bobbin to rotate about the central axis of the bobbin at a different speed from the rotation of the outer carrier 33 around the axis of rotation of the first shaft 42.

The second bobbin drive system is powered by a motor (not shown). The second bobbin drive system includes a main drive shaft 43 having a drive gear 48 and through which the flying leads pass. A second differential bevel gear 49 connects the drive gear 48 to a bobbin gear 44. The bobbin gear 44 is connected via a shaft 50 to the inner carrier 51. The bobbin carrier 38 is connected to the bobbin drive gear 44 via the inner carrier 51 and as the bobbin drive shaft 43 rotates about its axis it drives the bobbin carrier 38 about the bobbin's axis of rotation.

The first and second differential gears 34, 49 allow the input speeds of the rotating shafts 42 and 43 to be varied relative to one another without the flying leads becoming twisted as the centrifuge rotates.

FIG. 1 exemplifies the differential bevel gear 14 and the bobbin gear 20 having a gear ratio of 1:1. However various gear ratios may be used, such as using a smaller differential bevel gear which would allow the machine to be more compact, as long as the ratio of the bobbin gear 20 and the intermediate drive gear 12 remains at 1:1. FIGS. 1 and 2 exemplify “J” type coil centrifuges, however by altering the speed and the direction of rotation of the bobbins the centrifuge can run as either an “I” or a “J” type machine.

Current parallel axis centrifuges only allow limited relative speeds of the rotor and bobbin. For an “I” type centrifuge the relative bobbin speed to rotor speed is −1 while for “J” type centrifuges the relative bobbin speed to rotor speed is +1. But as the centrifuge of the invention allows the bobbin speed and rotor speed to be changed independently, it increases the configurations that the centrifuge can be ran at.

The centrifuge can include more than one bobbin as shown in FIG. 1 where the main drive system 4 is connected to a further bobbin drive system 21 which is connected to a second bobbin carrier 22 connected to the bobbin drive system 17.

Although the non-synchronous machine is particularly useful for separating polymers such as proteins, the machine can be used to separate other types of compounds.

1-13. (canceled)

14. A centrifuge comprising a:
a main drive system having a first axis of rotation;
a bobbin carrier for mounting a bobbin so as to have a bobbin axis of rotation that is parallel to and offset from the first axis of rotation;
a first transmission system connected to the main drive system and the bobbin carrier to transmit power from the main drive system to rotate the bobbin carrier around the first axis of rotation and to rotate the carrier around the bobbin axis of rotation;
a first bobbin drive system connected to the transmission system for driving the bobbin carrier around the bobbin axis of rotation;
wherein the first transmission system is connected to the bobbin carrier by a differential, such that the bobbin can rotate around the first axis of rotation at a different speed than the bobbin rotates around the bobbin axis of rotation.

15. A centrifuge according to claim 14 comprising a second bobbin drive system connected to the bobbin carrier to drive the carrier around the bobbin axis independently of the first bobbin drive system.

16. A centrifuge according to claim 14 wherein the first bobbin drive system comprises a main drive gear through which the first bobbin drive system connects to the main drive system, an intermediate drive gear connected to the main drive gear, and a differential gear connected to the intermediate drive gear and to the bobbin carrier.

17. A centrifuge according to claim 16 wherein the differential gear has a smaller diameter than the first drive gear and the bobbin gear.

18. A centrifuge according to claim 17 wherein the gear ratio of the bobbin gear and the intermediate drive gear is 1:1.

19. A centrifuge according to claim 16 wherein the bobbin carrier comprises a bobbin gear through which the bobbin carrier connects the bobbin to the differential gear of the first bobbin drive system.

20. A centrifuge according to claim 19 wherein the differential gear has a smaller diameter than the first drive gear and the bobbin gear.

21. A centrifuge according to claim 20 wherein the gear ratio of the bobbin gear and the intermediate drive gear is 1:1.

22. A centrifuge according to claim 16 wherein the intermediate drive gear has a larger diameter than the main drive gear.

23. A centrifuge according to claim 14 wherein the bobbin carrier can rotate around the first axis of rotation at a faster speed than the bobbin carrier rotates around the bobbin axis of rotation.

24. A centrifuge comprising:
a main drive system having a first axis of rotation;
a outer carrier connected to the main drive system which rotates around the first axis of rotation;
a bobbin carrier within the outer carrier for mounting a bobbin so as to have a bobbin axis of rotation that is parallel to and offset from the first axis of rotation;
a first bobbin drive system connected to the outer carrier for driving the bobbin carrier about the bobbin axis of rotation;
a first differential connected to the first bobbin drive system;
a second bobbin drive system connected to the bobbin carrier so as to drive the bobbin carrier around the bobbin axis of rotation independently of the first bobbin drive system;
a second differential connected to the second bobbin drive system;
wherein the first and second differentials are connected to the first and second bobbin drive systems such that the bobbin is rotatable about the first axis of rotation at a different speed than the bobbin is rotatable about the bobbin axis of rotation.

25. A centrifuge according to claim 24 wherein the first bobbin drive system comprises a first bobbin drive gear, and wherein the bobbin carrier comprises a bobbin gear connected to the bobbin drive gear.

26. A centrifuge according to claim 24 comprising a casing, wherein the first differential is connected to a stationary gear and the stationary gear is connected to the casing.

27. A centrifuge according to claim 24 wherein second bobbin drive system comprises a second bobbin drive gear, the second differential connected to the second bobbin drive gear and to a second bobbin gear connected to the bobbin carrier.

28. A countercurrent chromatography machine comprising a centrifuge according to claim 14.

29. A countercurrent chromatography machine comprising a centrifuge according to claim 24.
